(19) United States
(12) Patent Application Publication
(10) Pub. No.: US 2009/0115238 A1
(43) Pub. Date: May 7, 2009

(54) Truck Bed Lifting Device and Method

(75) Inventor: Thomas M. Lane, Chardon, OH (US)

Correspondence Address: WALKER & JOCKE, L.P.A., 231 SOUTH BROADWAY STREET, MEDINA, OH, 44256, US

(73) Assignee: International business machines corporation, Armonk, NY (US)

(21) Appl. No.: 11/933,656

(22) Filed: Nov. 1, 2007

(51) Int. Cl. B60P 1/16

(52) U.S. Cl. 298/22 C

(57) ABSTRACT

A lifting device mounted to a bed of a pickup truck is provided. The lifting device includes a lifting frame that includes first and second booms with a beam therebetween. The ends of the boom opposite the beam pivot with respect to the bed at pivot locations between the wheel wells and the tailgate. Trusses are mounted around each of the wheel wells along the sides of the bed. Hydraulic cylinders are mounted over the wheel wells between the frames and booms. The hydraulic cylinders are operated to urge the lifting frame to pivot with respect to the bed between a first position and a second position to move objects into and out of the bed. In the first position the beam extends over the truck and each boom extends over a respective one of the wheel wells. In the second position the beam extends behind the truck.

### TECHNICAL FIELD

This invention relates to pickup trucks. Specifically this invention relates to a method and apparatus for modifying a pickup truck to include a lifting device capable of moving one or more heavy work pieces into and out of the bed of the truck.

### BACKGROUND ART

Pickup trucks are well known. A typical pickup truck includes a separate cabin (referred to herein as a cab) from which the driver and passenger(s) may be seated. As used herein the term cab includes various different styles of cabs such as a standard cab, an extended cab, crew cab, and cab-forward design. In addition a typical pickup truck includes a rear load area or compartment referred to as a bed.

A typical bed of a pickup truck corresponds to a well-type bed that includes short rigid side walls. The back of such beds typically include an opening that may optionally include a rear gate (“tailgate”) for closing the opening. Such beds are positioned adjacent the rear wheels of the truck. Thus the side walls of the bed typically include portions of the rear wheel wells which extend into the bed. The minimum distance between the outer surfaces of the wheel wells on either side of the bed is typically smaller than the minimum distance between portions of the side walls on opposed sides of the bed that are adjacent to the wheel wells. Also the adjacent portions of the side walls of the bed typically extend higher and over the portions of the side wall that correspond to the wheel wells. As a result, the width of the bed, for accommodating objects adjacent the floor of the bed, is typically limited by the minimum width between the wheel wells. As an example, a truck with a “full-size long bed” may have a size that can carry a standard-sized 4×8 foot sheet of plywood or drywall with a closed tailgate.

A typical pickup truck includes a frame under the bed of the truck that provides sufficient structural support for enabling the bed of the truck to store heavy objects. The load capacity of a truck refers to the maximum amount of weight the truck is designed to safely handle. For example, the springs, chassis, bed and other structural features of a “one ton” truck may be capable of enabling the truck to carry several thousands of pounds in the bed of the truck.

Although pickup trucks are designed to carry heavy objects in the bed of the truck, such objects may have a weight which is too heavy for an individual to safely lift into the bed of the truck. As a result, there exists a need for a device operated by a single person which can be used to move heavy objects into and out of a bed of a pickup truck.

### DISCLOSURE OF INVENTION

It is an object of at least one embodiment of at least one of the inventions described herein to provide a method and a device which can be used to move heavy objects into and out of a bed of a pickup truck.

It is a further object of at least one embodiment of at least one of the inventions described herein to provide a method and a device which can be used by a single person to move heavy objects into and out of a bed of a pickup truck.

Further objects of embodiments of at least one invention described herein will be made apparent in the following Best Modes For Carrying Out Invention and the appended claims.

The foregoing objects may be accomplished by a lifting device that is operative to mount to a bed of a truck. The truck may correspond to a pickup truck and includes a bed located between a cab and a back of the truck. The truck also includes portions of a first wheel well and a second wheel well that extend into the bed.

The lifting device includes a lifting frame operative to mount in pivoting connection with the bed of the truck. The lifting frame includes a first boom and a second boom. Each of the first and second booms includes a first end and a second end. Also, the lifting frame includes at least one beam extending between the first ends of the first and second booms. In an example embodiment the beam may include a hoisting device mounted thereto such as a winch, a come along, a chain fall, or other device operative to lift and lower objects relative to the beam.

In this described embodiment the lifting device includes at least one hydraulic cylinder that is mounted to one of the first or second booms and is operative to urge the lifting frame to pivot with respect to the truck. In this described embodiment or in alternative embodiments, the lifting device may include more than one hydraulic cylinder such as a first hydraulic cylinder and a second hydraulic cylinder that are respectively mounted to the first and second booms. In addition the lifting device may include a hydraulic control system capable of controlling the operation of the at least one hydraulic cylinder. In embodiments that include two hydraulic cylinders, the hydraulic control system is also capable of controlling both hydraulic cylinders to simultaneously urge the lifting device to pivot.

In an exemplary embodiment the hydraulic control system may include a pump and one or more valves which are operative to provide hydraulic fluid pressure sufficient to operate the at least one hydraulic cylinder. Such a hydraulic cylinder may include a piston that moves within a cylinder barrel responsive to hydraulic fluid pressure provided by the hydraulic pump. In response to movement of the piston, a rod connected to the piston moves longitudinally to provide a pushing or pulling force that urges the first and/or second boom of the lifting device to pivot.

In an exemplary embodiment, the lifting device includes a configuration that when mounted to the truck, the respective second ends of the first and second booms are operative to pivot with respect to the bed at respective first and second pivot locations located between the respective first and second wheel wells and the back of the truck. In this described configuration of the lifting device, at least a portion of at least one hydraulic cylinder (such as its rod) extends over at least a portion of the one of the wheel wells. In embodiments that include two hydraulic cylinders, at least a portion of the first hydraulic cylinder (such as its rod) extends over at least a portion of the first wheel well and at least a portion of the second hydraulic cylinder (such as its rod) extends over at least a portion of the second wheel well.

The hydraulic control system is operative to selectively control the operation of the first hydraulic cylinder and/or the second hydraulic cylinder to urge the lifting frame to pivot with respect to the bed from a first position to a second position. In the first position the beam extends over the truck and the respective first and second booms extend over the respective first and second wheel wells. In the second position the beam extends over an area behind the truck. In addition the hydraulic control system is operative to urge the lifting frame to pivot with respect to the bed from the second position to the first position.

As discussed previously, the beam of the lifting frame may include a hoisting device operative to lift a workpiece toward the beam. For example, when the lifting frame is in the second position and a workpiece located behind the truck is placed in operative connection with the beam through operation of the hoisting device, the hydraulic control system is operative to cause the at least one hydraulic cylinder to urge the lifting frame to pivot to the first position and place the workpiece on the floor of the bed between the first and second booms of the lifting frame.

To remove the workpiece from the truck, the hydraulic control system is operative to cause the at least one hydraulic cylinder to urge the lifting frame to pivot to the second position and place the workpiece over the area behind the back of the truck. The hoisting device may then be operated to lower the workpiece from the beam of the lifting frame.

In this described embodiment, when the lifting frame is in the first position, the first and second booms extend over the wheel wells. As a result the space between the wheel wells and the first and second booms remains clear so that the lifting frame does not obstruct the space in the bed between the wheel wells. Thus, when the described lifting device is mounted to a full sized pickup truck that has a bed designed to carry 4×8 foot sheets of plywood lying horizontally on the floor bed between its wheel wells, the lifting frame does not reduce the space in the floor bed for carrying such 4×8 foot sheets of plywood.

An embodiment of at least one invention described herein includes a method of installing and using the described lifting device in a pickup truck. The method may include mounting the lifting frame in pivoting connection with a bed of a truck such that the respective second ends of the first and second booms are mounted to pivot with respect to the bed at respective first and second pivot locations located between the respective first and second wheel wells and the back of the truck. In addition, the method includes either prior or subsequent to mounting the lifting frame to the truck, mounting the at least one hydraulic cylinder in operative connection with the one of the booms. In embodiments with two hydraulic cylinders, the method may include: mounting the first hydraulic cylinder in operative connection with the first boom; and mounting the second hydraulic cylinder in operative connection with the second boom. As discussed previously, after mounting the first and second hydraulic cylinders, at least a portion of each of the first and second hydraulic cylinders extends over at least a portion of the respective wheel wells.

In addition the method may include operating the at least one hydraulic cylinder to urge the lifting frame to pivot with respect to the bed between the first position and the second position. Also with the lifting frame in the second position, the method may include connecting a workpiece located behind the truck to the beam. The hoisting device may be operated to lift the workpiece closer to the beam. Further the method may include operating the at least one hydraulic cylinder to urge the lifting frame to the first position so that the workpiece is moved to rest on the floor of the bed between the first and second booms of the lifting frame. Prior to the lifting frame reaching the first position, the hoisting device may also be operated to lower the workpiece in a designated location on the floor of the bed of the truck.

To move the workpiece out of the truck, the method may include operating the at least one hydraulic cylinder to urge the lifting frame to the second position so that the workpiece can be moved from the floor of the bed to a location behind the truck. The hoisting device may also be operated to lift and lower the workpiece with respect to the beam as needed.

In these described embodiments, the bed of the truck may include first and second side walls extending between the cab and the back end of the bed. Each of the first and second side walls include an inner surface in the interior of the bed. The inner surfaces of the respective first and second side walls include outer surfaces of the respective first and second wheel wells. Also, the inner surfaces of the first and second side walls each include a back portion positioned between the respective first and second wheel wells and the back of the bed. The minimum distance between the outer surfaces of the first and second wheel wells is smaller than the minimum distance between the back portions of the inner surfaces of the first and second side walls of the bed. In the described embodiments, the first and second pivot locations are located adjacent respective portions of the floor of the bed that are adjacent the respective back portions of the inner surfaces of the side walls of the cab.

In addition, the lifting device may include a first support frame mounted to the truck adjacent the inner surface of the first side wall of the bed. The lifting device may also include a second support frame mounted to the truck adjacent the inner surface of the second side wall of the bed. The first and second support frames may each include a first end and a second end. The respective first ends of the first and second support frames extend to the respective first and second pivot locations. Also the respective second ends of the first and second booms are in pivoting connection with the respective first ends of the first and second support frames. In addition the respective second ends of the first and second support frames extend to further locations between the cab and the wheel wells. Further, each of the first and second support frames include at least a portion that extends over the respective first and second wheel wells.

Also in the described embodiments, the first hydraulic cylinder includes a first end (such as the barrel end) and a second end (such as the rod end) or vice versa. Likewise the second hydraulic cylinder also includes a first and a second end. The first end of the first hydraulic cylinder may be in pivoting connection with the second end of the first support frame. Also the second end of the first hydraulic cylinder may be in pivoting connection with the first boom of the lifting frame. Similarly the first end of the second hydraulic cylinder may be in pivoting connection with the second end of the second support frame. Also the second end of the second hydraulic cylinder may be in pivoting connection with the second boom of the lifting frame.

In this described embodiment, beams may be connected to and extend between the support frames along the floor of the bed. Such beams may traverse portions of the frame and may be bolted to the frame to rigidly fasten the lifting device to the truck.

In the described embodiments, the first and second support frames may each be in the form of a truss comprised of a first vertical post in operative connection between an upper cord and a lower cord The first vertical posts of the first and second support frames may be located at the second ends of the first and second support frames. The upper cord of the first support frame extends over the first wheel well to avoid reducing the space between the wheel wells. The lower cord of the first support frame may extend along the floor of the bed adjacent the first wheel well. Similarly the upper cord of the second support frame extends over the second wheel well. Also the lower cord of the second support frame may extend along the floor of the bed adjacent the second wheel well. Although the lower cords may be located between the wheel wells, they may be mounted flush with the floor and side surface of the wheel wells to minimize decreasing the available space for placing objects between the wheel wells.

As will be appreciated, the foregoing objects and examples are exemplary and embodiments need not meet all or any of the foregoing objects, and need not include all or any of the exemplary features described herein. Additional aspects and embodiments within the scope of the claims will be devised by those having skill in the art based on the teachings set forth herein.

### BRIEF DESCRIPTION OF DRAWINGS

FIG. 1 is a perspective view representative of an embodiment of a lifting device mounted in the bed of a pickup truck.

FIG. 2 shows a side schematic view of the back of the truck with the tailgate down showing a lifting frame of the lifting device in a first position.

FIG. 3 shows a side plan schematic view of the truck in which the right hand side wall of the bed has been removed to show example positions in which the lifting frame may be pivoted with respect to the bed of the truck.

FIG. 4 shows a top plan schematic view of the truck with the lifting frame in the first position.

FIGS. 5-7 show examples of different configurations for a support frame.

FIG. 8 shows an alternative embodiment of the lifting device in which a portion of the vertical post that extends above the connecting point for the hydraulic cylinder extends to a height generally corresponding to the height of the cab.

FIG. 9 shows an alternative embodiment in which the lifting frame includes a further vertical post with a bracket adapted to support a ladder or other elongated object that extends over the bed of the truck.

FIG. 10 shows an optional portable brace that may be mounted to the hitch of the truck to support the back of the truck during use of the lifting device.

### BEST MODES FOR CARRYING OUT INVENTION

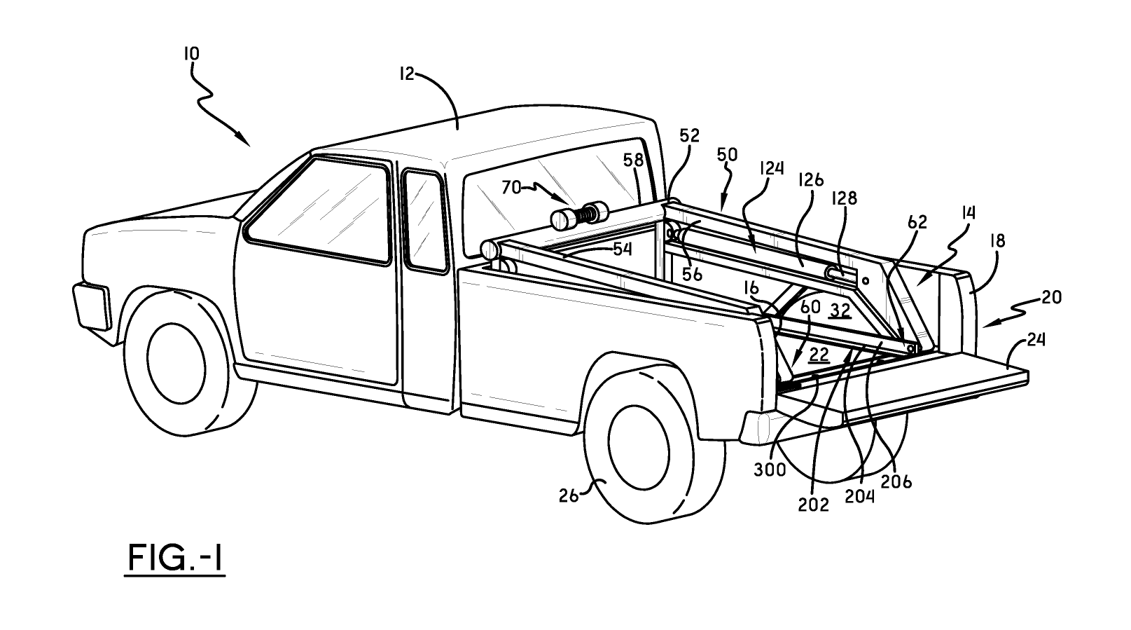

Referring now to the drawings and particularly to FIG. 1, there is shown therein a perspective view of an example pickup truck 10. The truck includes a cab 12 and a bed 14. The bed includes side walls 16 and 18 which extend between the cabin 12 and the back of the truck 20. A bed also includes a floor 22 between the side walls, which floor is supported by the frame of the truck. The back of the bed may further include a tailgate 24 operative to close a rear opening into the bed.

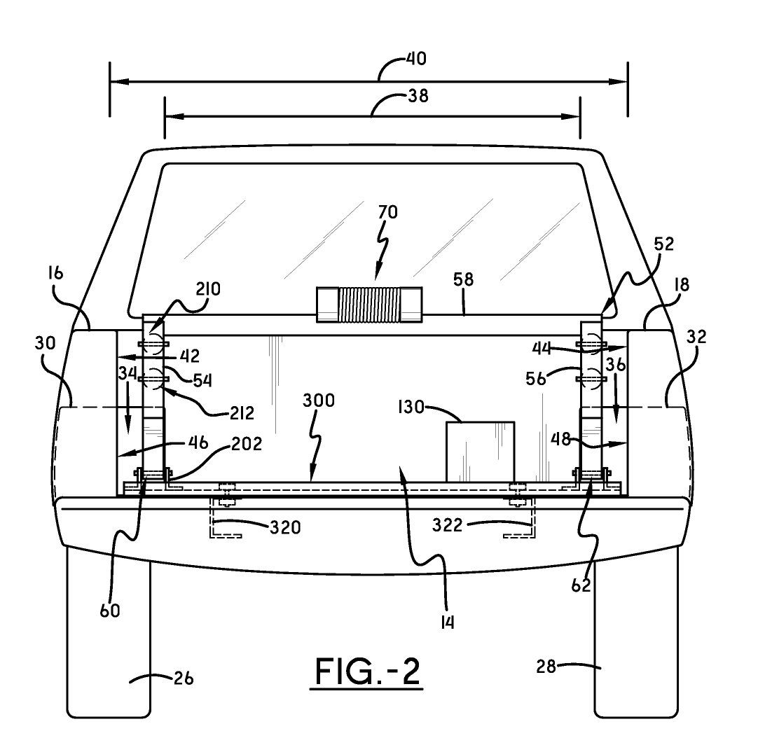

FIG. 2 shows a side schematic view of the back of the truck which shows the rear tires 26 and 28 of the truck. Such rear tires are at least partially covered by wheel wells 30 and 32. Such wheel wells include outer surfaces 34 and 36 which extend into the bed 14 and form portions of the inner surfaces of the side walls 18 and 16 of the bed. Because the wheel wells extend into the bed, the minimum distance 38 between the wheel wheels 30, 32 on opposed sides of the bed is less than the minimum distance 40 between portions of the side walls adjacent the wheel wells on opposed sides of the bed (e.g. portions 42, 44 of the side walls above the wheel well, and portions 46, 48 of the side walls beside the wheel wells).

Referring back to FIG. 1, an embodiment of at least one invention described herein includes a lifting device 50 which is mounted to the truck 10. The lifting device includes a lifting frame 52 comprised of a first boom 54 and a second boom 56 located on opposite sides of the bed. These booms each include opposed first ends and second ends. The lifting frame also includes a beam 58 mounted between the first ends of the booms 54, 56. Such a beam may be welded or otherwise fastened to the first ends of the booms, such that the booms extend from the beam generally parallel to each other. The resulting lifting frame has a generally upside down “U” shaped appearance.

As shown in FIG. 2, when the lifting frame is installed on the truck the second ends of the booms are operative to pivot about pivot locations 60, 62 located between the wheel wells 30, 32 and the back of the truck. Also, the lifting frame may be sufficiently wide that the pivot locations 60, 62 are located adjacent the inside surfaces 46, 48 of the side walls. Thus the minimum distances between the booms corresponds to or is greater than the minimum distance 38 between the wheel wells.

In this described embodiment, the pivot locations 60, 62 may be located closer to the tailgate than the wheel wells. For example, as shown in FIG. 1, the pivot locations 60, 62 may be adjacent the tailgate in positions, such that when the lifting frame is in the first position shown in FIG. 1, the tailgate may be moved to a closed position.

Embodiments of the booms and beam of the lifting frame may be comprised of steel or other materials that are sufficiently strong to support lifting of an object attached to the beam. For large pickup trucks, the lifting frame may be capable of supporting 1,000 pounds and heavier objects. In an embodiment, the beam may include a hoisting device 70 that may be used to lift a workpiece towards the beam and lower objects below the beam. Examples of a hoisting device include a winch, a come along, a chain fall, or other device operative to lift and lower objects relative to the beam.

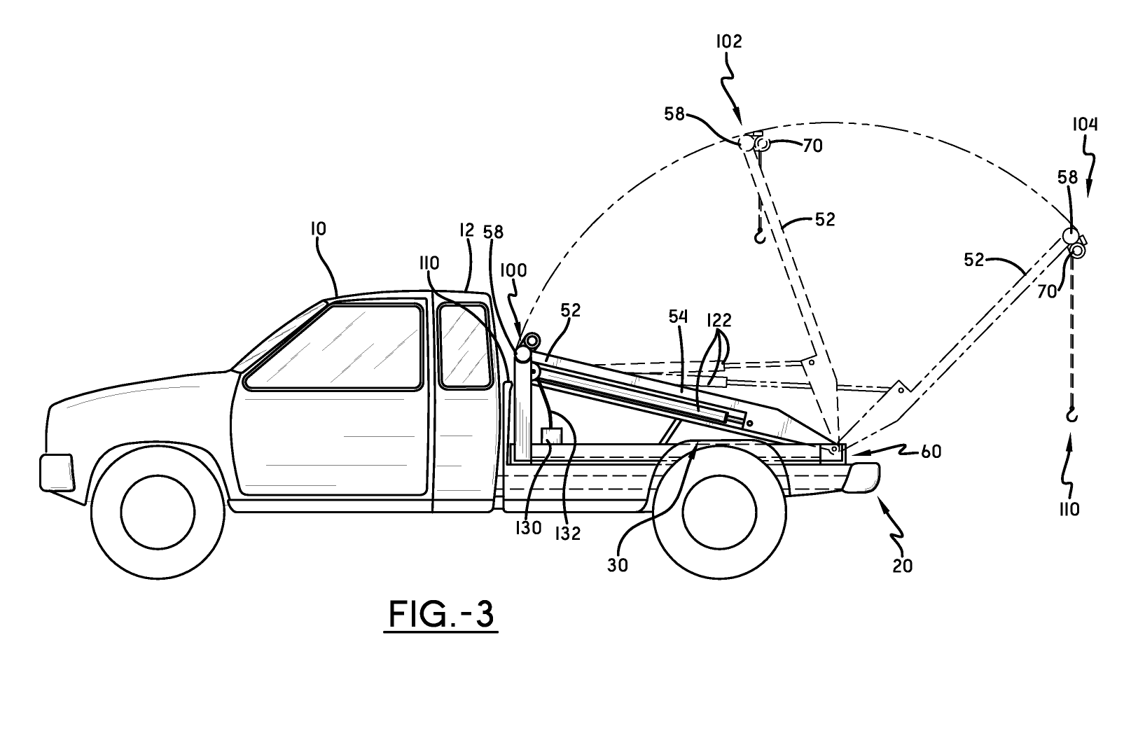

FIG. 3 shows a side plan schematic view of the truck 10 in which the right hand side wall of the bed has been removed to show example positions 100, 102, 104 in which the lifting frame 52 may be pivoted with respect to the bed of the truck. For example, in a forward lower first position 100, the majority of the lifting frame is lower than the top edge 110 of the side walls of the bed. Although in this first position, the beam 58 is shown extending above the top edge 110 of the side walls, it is to be understood that in alternative embodiments, the lifting device may be configured to enable the entire lifting frame, including the beam to move to a position that is lower than the top edge 110 of the side walls of the bed.

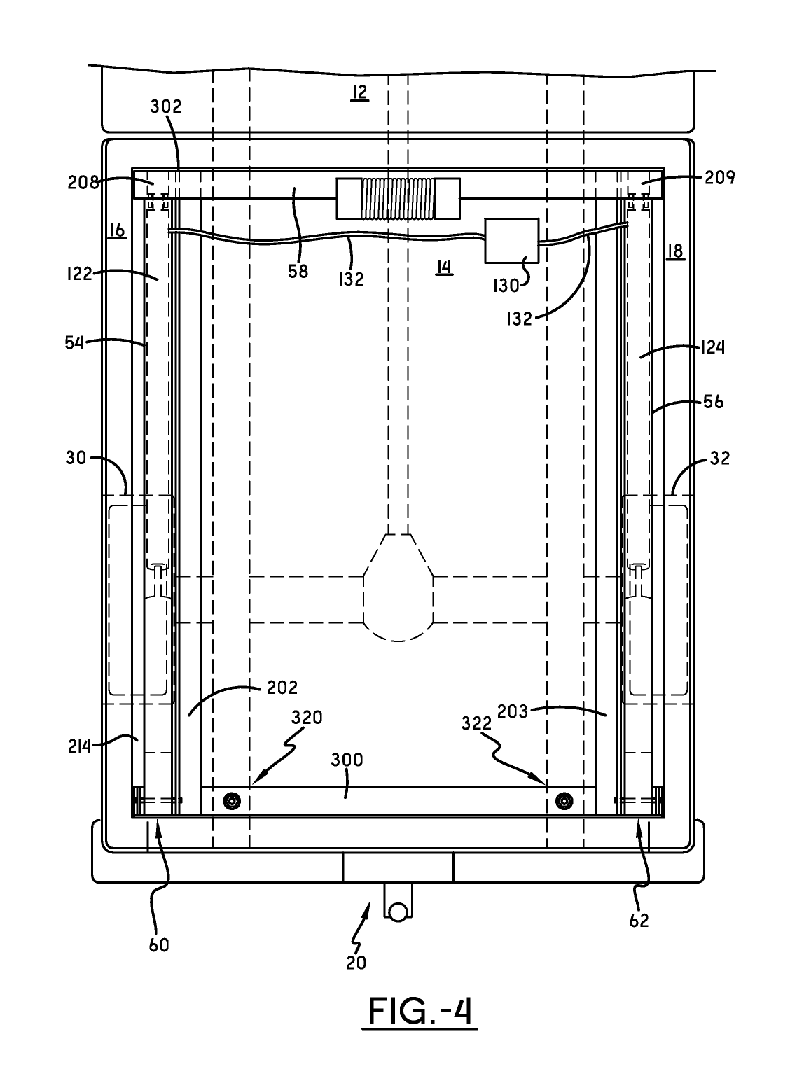

In the first position, the lifting frame has a shape in which the booms of the lifting frame extend over the wheel wells. For example as shown in FIG. 3, in the first position, the boom 54 extends from the pivot location 60 adjacent the back 20 of the truck, across the left wheel well 30 to a position adjacent the cab 12 of the truck. FIG. 4 shows a top plan schematic view of the truck with the lifting frame in the first position. In the same manner as the left hand boom 54 extends over the left hand wheel well 30, the right hand boom 56 extends from the pivot point 32 adjacent the back 20 of the truck, across the right hand wheel well 32 to a position adjacent the cab 12. With the lifting frame in this first position, the beam 58 between the booms extends over the truck such as over the portion of the bed 14 adjacent the cab 12.

Referring back to FIG. 3, to move a workpiece into the bed of the truck, the lifting frame 52 may be moved from the first position 100 through various intermediate positions 102 to the second position 104. In the second position 104, the beam 58 extends over an area 110 behind the truck. In this position the hoisting device 70 may be operated to lift a workpiece located in the area 110 behind the truck towards the beam 58. The lifting frame may then be pivoted back to the first position, which places the workpiece onto the bed of the truck. It is to be understood that depending on the size of the workpiece being lifted and the distance the workpiece is lifted using the hoisting device, the lifting beam may be stopped in an intermediate position 102 to enable the hoisting device to be operated to lower the workpiece to an appropriate location on the floor of the bed of the truck. Once the workpiece is seated in the bed, the lifting frame can be moved to the first position before the truck is driven.

To remove the workpiece from the bed of the truck, the lifting device may be operated to move the lifting frame from the first position 100, through the various intermediate positions 102, to the second position 104. Also, while the lifting device is in an intermediate position, the hoisting device may operated to lift the workpiece toward the beam and off of the bed of the truck. When the lifting frame reaches the second position 104, the hosting device may then be operated to lower the workpiece from the beam to a location 110 (e.g. the ground) behind the truck.

To pivot the lifting frame between the first and second positions, embodiments of the lifting device may include one or more hydraulic cylinders 122, 124 connected via hydraulic lines 132 to a hydraulic control system comprised of a pump 130 and one or more valves. The pump and one or more valves in the hydraulic control system may be selectively operated to control the hydraulic fluid pressure needed to cause the hydraulic cylinders to push and pull the lifting frame between the first and second positions.

The described embodiment includes a hydraulic cylinder 122, 124 associated with each respective boom 54, 56. However it is to be understood that in an alternative embodiment, the lifting device may be configured to use only a single hydraulic cylinder to urge the lifting frame between the first and second positions.

As shown in FIG. 1 (with respect to the right-hand hydraulic cylinder) each hydraulic cylinder includes a rod 128 that slides longitudinally with respect to a barrel 126. A piston (not shown) within the barrel is responsive to hydraulic pressure within the barrel to move the rod. Movement of the rod outwardly provides a pushing force operative to urge the lifting frame 52 from the second position to the first position. Movement of the rod inwardly provides a pulling force operative to urge the lifting frame from the second position to the first position.

In the exemplary embodiment, a first end of each hydraulic cylinder (such as the rod 128) is in pivoting connection with a respective boom (such as boom 56). The second end of each hydraulic cylinder (such as the barrel 126) is in pivoting connection with the truck via a respective structural member anchored to the truck located between the cab 12 and a respective wheel well (such as wheel well 32).

In the exemplary embodiments shown in the drawings, the second ends of the hydraulic cylinders are in pivoting connection with structural members in the form of support frames capable of reinforcing the structural integrity of the lifting device between the pivot locations 60, 62 of the booms and the anchor locations for the hydraulic cylinders.

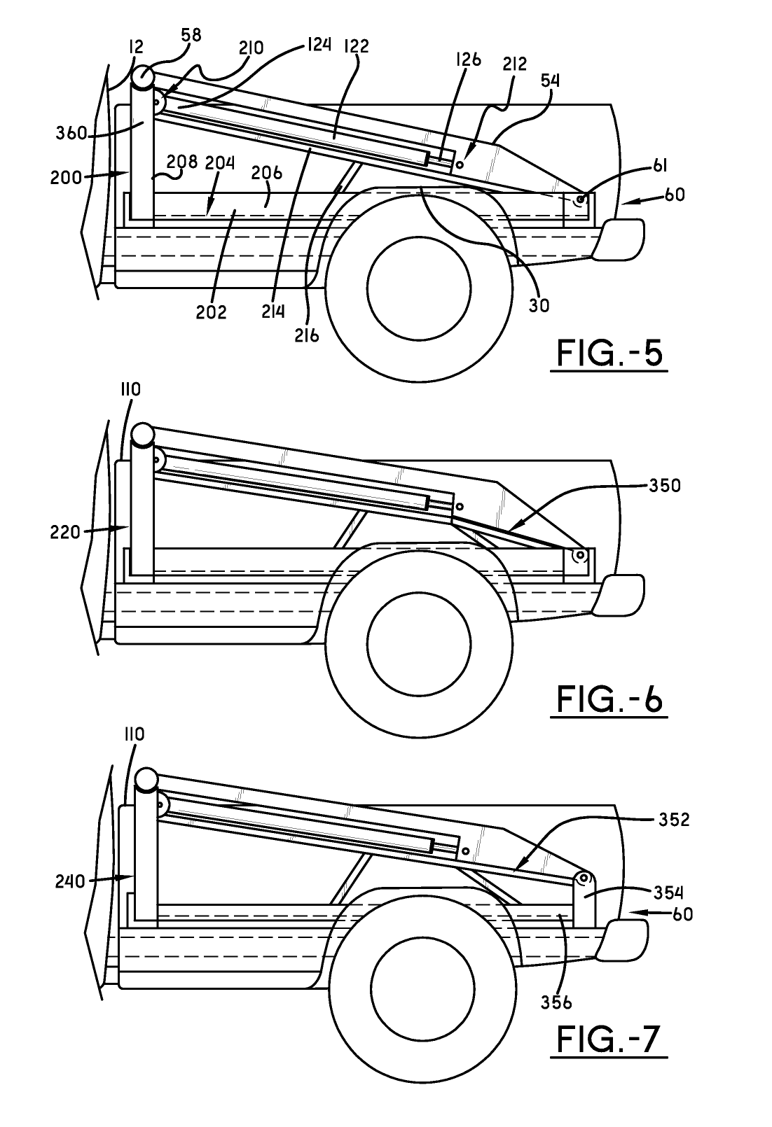

FIGS. 5-7 show examples of different configurations for support frames that may be included in the lifting device. Each of FIGS. 5-7 shows a side plan schematic view of the truck with the left-hand side wall of the bed removed. In the described embodiment the truck includes two support frames (one for each boom). FIGS. 5-7 show examples of the support frame 200, 220, 240 located on the left hand side of the bed.

As shown in FIG. 5, a support frame 200 may be in the form of a truss that includes a lower cord 202 that extends along the floor of the bed from the pivot location 60 to between the cab 12 and the wheel well 30. In this described embodiment of the support frame 200, the boom 54 is in pivoting connection with the lower cord at the pivot location 60 using a pin 61.

As discussed previously the wheel well 30 extends into the floor of the bed further than adjacent portions of the side walls of the bed. To minimize the amount of space that the lower cord consumes in the bed between the wheel wells, the lower cord may correspond to an angled beam such as an angle iron bent at ninety degrees (or other angle) along its length to form a structural member with an “L” shape in cross-section. As shown in FIG. 1 with respect to the support frame on the opposite side of the bed, the base 204 of the angled beam 202 may lie parallel to the floor of the bed 22, while the back 206 of the angled beam is posited to abut the wheel well 32.

Referring back to FIG. 5, the support frame 200 may further include a vertical post 208 in operative connection with the end of the lower cord between the cab 12 and the wheel well 30. An end of the hydraulic cylinder 122 such as the barrel 124 is in pivoting connection with the vertical post 208 at a location 210, whereas the opposite end of the hydraulic cylinder 122 such as the rod 126 is in pivoting connection with the boom 54 at a location 212. In this described embodiment the location 212 at which the rod 126 is connected to the boom may be located closer to the pivot location 60 than to the beam 58.

In this described embodiment, the support frame 202 may also include an upper cord 214 that extends between the vertical post 208 and the portion of the bottom cord 202 that is adjacent the pivot location 60. As a result, the support frame 202 is in the configuration of a truss with a generally triangular shape. For further structural support, the support frame may also include one or more web beams 216 extending between the lower and upper cords 202, 214 and/or the vertical post 208.

As shown in FIG. 4 the upper cord 214 extends directly over the wheel well 30. Thus the minimum distance between the support members adjacent each side wall of the bed is equal to or greater than the minimum distance between the wheel wells. Thus in this described embodiment, neither the upper cord of the support members nor the booms of the lifting member consume space in the bed between the wheel wells.

In an embodiment the lifting device includes at least two horizontal beams adjacent the floor of the bed which connect the opposed support members on each side of the bed. For example as shown in FIG. 4 the lifting device may include a horizontal beam 300 at the back of the bed which connects the ends of the lower cords of the support members that are adjacent the pivot locations 60, 62. In addition, the lifting device may include a second horizontal beam 302 near the cab of the truck that connects the lower cords 202, 203 of the support members adjacent the vertical posts 208, 209. Such horizontal beams 300, 302 may correspond to angled beams such as angle irons bent at ninety degrees (or other angle) along their lengths to form structural members with an “L” shape in cross-section. As shown in FIG. 2, the horizontal beams (such as beam 300) may be bolted to portions 320, 322 of the frame of the truck which extend under the bed.

In embodiments of the lifting device, other configurations of the support frame may also be used, depending on the size of the truck and the location of the wheel wells in the bed of the truck. For example FIGS. 6 and 7 show examples of trucks with wheel wells which extend higher in the bed relative the side walls of the bed compared to that shown in the truck in FIG. 5. To accommodate the higher wheel wells as shown in FIG. 6, the upper cord 350 of the support frame 220 may be bent to extend over the wheel well and still maintain the upper cord below the top edge 110 of the side walls of the bed. In FIG. 7 to maintain the upper cord below the top edge 110 of the side walls, a second vertical post 354 adjacent the back of the bed may be positioned between the upper 352 cord and lower cord 356 of the support frame 240.

As shown in FIG. 5 the vertical post 208 of each of the support frames in the bed may include a portion 360 that extends above the location 210 at which the hydraulic cylinder 122 connects to the vertical post 280. Such portion 360 of the vertical posts of the support frames may include upper surfaces that are adapted to sportingly receive the ends of the beam 58 when the lifting frame is in the first position.

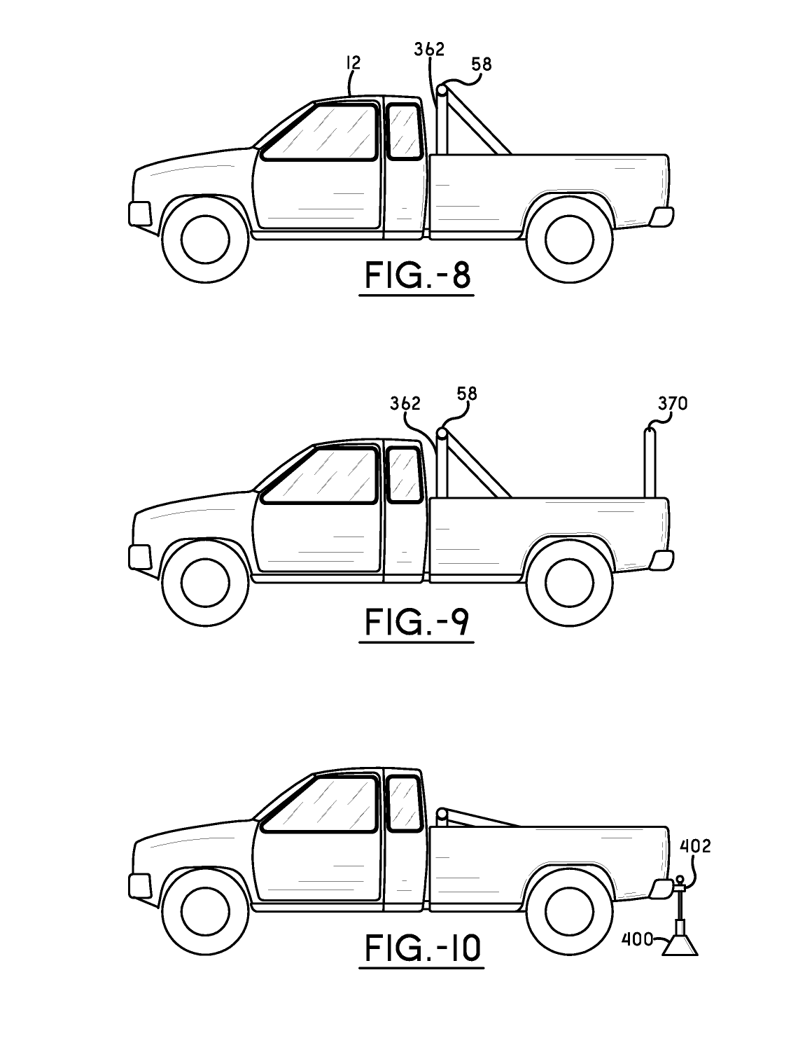

As shown in FIG. 8 in an alternative embodiment, a portion 362 of the vertical post that extends above the connecting point for the hydraulic cylinder may extend to a height within a foot of the height of the cab. As a result when the beam is resting on the vertical posts of the support frame, the configuration of the lifting device above the side walls of the bed resembles a roll bar.

In addition, further alternative embodiments of the lifting device may include features for mounting tools or other objects. For example as shown in FIG. 9, one or more further vertical posts 370 may be mounted to portions of the lifting device adjacent the back of the truck, which include brackets. Brackets may also be installed on portions of the vertical posts 362 or beam 58. Such brackets located on opposite ends of the lifting device may be configured to sportingly hold elongated objects such as ladders, lumber, pipes and other materials.

Although the described lifting devices are shown extending adjacent the cab 12 of the truck, it is to be understood that in alternative embodiments the lifting device may be made shorter to accommodate the mounting or storing of other objects between the cab and the lifting device such as a tool chest, fuel tanks or other objects.

In addition, although the hydraulic pump 130 is shown in FIG. 4 as a dedicated pump mounted in the bed of the truck, it is to be understood that in alternative embodiments, the hydraulic pump may be mounted elsewhere in the truck. Likewise valves associated with the control and/or direction of hydraulic fluid pressure may also be located adjacent the pump or elsewhere in the truck. Further existing hydraulic pumps in the engine compartment may be adapted to additionally supply hydraulic fluid pressure to the hydraulic cylinders of the lifting device.

Also, in further embodiments the lifting device may include optional components that are mounted to the truck when the lifting device is used to move heavy objects into and out of the truck. For example, as shown in FIG. 10 a portable brace 400 may be mounted to the hitch 402 or other portion of the truck to support the rear of the truck when large amounts of downward forces are applied to the rear of the truck as the lifting device moves between the first and second positions.

In addition, embodiments of the lifting device may be mounted to other types of vehicles such as a flat bed truck. In such embodiments the mounting location and configuration of the support frame may be adapted to correspond to the particular contour and design of the bed of the vehicle.

Also in embodiments, the lifting device may be used for purposes other than lifting objects into the bed of the truck. For example, to tow a vehicle on the back of the truck, the described lifting device could be used to raise an end of the vehicle so that the tires adjacent the raised end of the vehicle are above the ground. The raised end of the vehicle may then be mounted to a hitch on the back of the truck.

Also in embodiments, other types of devices may be mounted to the beam 58 for use with moving objects into and out of the bed of the truck. For example, a dump bucket or other reservoir may be suspended from the beam 58 and/or a hoisting device on the beam.

Thus the new truck bed lifting device and method achieves one or more of the above stated objectives, eliminates difficulties encountered in the use of prior devices and systems, solves problems and attains the desirable results described herein.

In the foregoing description certain terms have been used for brevity, clarity and understanding, however no unnecessary limitations are to be implied therefrom because such terms are used for descriptive purposes and are intended to be broadly construed. Moreover, the descriptions and illustrations herein are by way of examples and the invention is not limited to the exact details shown and described.

In the following claims any feature described as a means for performing a function shall be construed as encompassing any means known to those skilled in the art to be capable of performing the recited function, and shall not be limited to the features and structures shown herein or mere equivalents thereof. The description of the exemplary embodiment included in the Abstract included herewith shall not be deemed to limit the invention to features described therein.

Having described the features, discoveries and principles of the invention, the manner in which it is constructed and operated, and the advantages and useful results attained; the new and useful structures, devices, elements, arrangements, parts, combinations, systems, equipment, operations, methods and relationships are set forth in the appended claims.

I claim:

1. A method comprising:
a) mounting a lifting frame in pivoting connection with a bed of a truck, wherein the bed includes portions of a first and a second wheel well extending therein, wherein the lifting frame includes a first boom and a second boom, wherein each of the first and second booms includes a first end and a second end, wherein the lifting frame includes at least one beam extending between the first ends of the first and second booms, wherein the respective second ends of the first and second booms are mounted to pivot with respect to the bed at respective first and second pivot locations located between the respective first and second wheel wells and a back of the truck;
b) wherein either prior to or subsequent to (a) mounting a first hydraulic cylinder in operative connection with the first boom, wherein after (a) and (b) at least a portion of the first hydraulic cylinder extends over at least a portion of the first wheel well; and
c) operating the first hydraulic cylinder to urge the lifting frame to pivot with respect to the bed between a first position and a second position, wherein in the first position the beam extends over the truck and the respective first and second booms extend over the respective first and second wheel wells, wherein in the second position the beam extends over an area behind the truck.

2. The method according to claim 1, further comprising:
d) with the lifting frame in the second position, connecting a workpiece located behind the truck to the beam;
e) operating the first hydraulic cylinder to urge the lifting frame to the first position, wherein the workpiece is moved to rest on the floor of the bed between the first and second booms of the lifting frame.

3. The method according to claim 2, wherein the beam includes a hoisting device, wherein after (d) further comprising operating the hoisting device to lift the workpiece towards the beam.

4. The method according to claim 3, further comprising:
f) subsequent to (e) operating the first hydraulic cylinder to urge the lifting frame to the second position, wherein the workpiece is moved from the floor of the bed to a location behind the truck.

5. The method according to claim 4, further comprising operating the hoisting device to lower the workpiece away from the beam.

6. The method according to claim 1, further comprising:
d) prior to (c) mounting a second hydraulic cylinder in operative connection with the truck and the second boom, wherein at least a portion of the second hydraulic cylinder extends over at least a portion of the second wheel well;
wherein (c) includes operating the first and second hydraulic cylinders to urge the lifting frame to the second position.

7. The method according to claim 6, wherein in (a) the truck includes a cab, wherein the bed of the truck includes a back end and a front end, wherein the front end of the bed is bounded by a portion of the cab, wherein the bed includes first and second side walls extending between the cab and the back end of the bed, wherein each of the first and second side walls includes an inner surface in the interior of the bed, wherein the inner surfaces of the respective first and second side walls include outer surfaces of the respective first and second wheel wells, wherein the inner surfaces of the first and second side walls each include a back portion positioned between the respective first and second wheel wells and the back of the bed, wherein the minimum distance between the outer surfaces of the first and second wheel wells is smaller than the minimum distance between the back portions of the inner surfaces of the first and second side walls of the bed, wherein the bed includes a floor between the first and second side walls, wherein the first and second pivot locations are located adjacent respective portions of the floor of the bed that are adjacent the respective back portions of the inner surfaces of the side walls of the bed.

8. The method according to claim 7, prior to (c) further comprising:
e) mounting a first support frame adjacent the inner surface of the first side wall of the bed;
f) mounting a second support frame adjacent the inner surface of the second side wall of the bed, wherein the first and second support frames each include a first end and a second end, wherein the respective first ends of the first and second support frames extend to the respective first and second pivot locations, wherein the respective second ends of the first to and second booms are in pivoting connection with the respective first ends of the first and second support frames, wherein the respective second ends of the first and second support frames extend to further locations between the cab and the wheel wells, wherein each of the first and second support frames includes at least a portion that extends over the respective first and second wheel wells, wherein the first hydraulic cylinder includes a first and a second end, wherein the second hydraulic cylinder includes a first and a second end;
wherein (b) includes mounting the first end of the first hydraulic cylinder in pivoting connection with the second end of the first support frame, wherein (b) includes mounting the second end of the first hydraulic cylinder in pivoting connection with the first boom of the lifting frame;
wherein (d) includes mounting the first end of the second hydraulic cylinder in pivoting connection with the second end of the second support frame, wherein (d) includes mounting the second end of the second hydraulic cylinder in pivoting connection with the second boom of the lifting frame;

9. The method according to claim 8, wherein the truck includes a truck frame located under the floor of the bed, wherein the first and second support frames are each in a form of a truss comprised of a first vertical post in operative connection between an upper cord and a lower cord, wherein the first vertical posts of the first and second support frames are located at the second ends of the first and second support frames, wherein the upper cord of the first support frame extends over the first wheel well, wherein the lower cord of the first support frame extends along the floor of the bed adjacent the first wheel well, wherein the upper cord of the second support frame extends over the second wheel well, wherein the lower cord of the second support frame extends along the floor of the bed adjacent the second wheel well, wherein the lifting device includes at least one horizontal beam extending between the first and second support frames, further comprising:
g) fastening the at least one horizontal beam to the truck frame.

10. The method according to claim 9, wherein portions of the second ends of the first and second support frames extend above the first and second side walls, wherein in (c) in the first position at least one of the beam and the first ends of the first and second booms comes to rest in supporting connection with the portions of the second ends of the first and second support frames that extend above the first and second side walls.

11. The method according to claim 6, wherein the lifting device includes at least one bracket located above the back of the bed, wherein portions of the bracket extend above the first side wall, further comprising:
e) loading a ladder in supporting connection with the at least one bracket.

12. An apparatus comprising:
a lifting device operative to mount to a truck that includes a bed between a cab and a back of the truck, which truck includes portions of a first wheel well and a second wheel well that extend into the bed, wherein the lifting device includes:
a lifting frame, wherein the lifting frame includes a first boom and a second boom, wherein each of the first and second booms includes a first end and a second end, wherein
the lifting frame includes at least one beam extending between the first ends of the first and second booms;
a first hydraulic cylinder in pivoting connection with the first boom;
a hydraulic control system in operative connection with the first hydraulic cylinder;
wherein the lifting device includes a configuration that when mounted to the truck:
the respective second ends of the first and second booms are operative to pivot with respect to the bed at respective first and second pivot locations located between the respective first and second wheel wells and the back of the truck;
at least a portion of the first hydraulic cylinder extends over at least a portion of the first wheel well;
the hydraulic control system is operative to selectively control the operation of the first hydraulic cylinder to:
urge the lifting frame to pivot with respect to the bed from a first position to a second position, wherein in the first position the beam extends over the truck and the respective first and second booms extend over the respective first and second wheel wells, wherein in the second position the beam extends over an area behind the truck; and
urge the lifting frame to pivot with respect to the bed from the second position to the first position.

13. The apparatus according to claim 12, further comprising the truck, wherein the second ends of the first and second booms are in operative connection with the truck such that the second ends of the first and second booms are operative to pivot with respect to the bed at the first and second pivot locations, wherein the first hydraulic cylinder is in operative connection with the first boom such that the first hydraulic cylinder extends over at least the portion of the first wheel well, wherein the hydraulic control system is in operative connection with the truck and is operative to selectively control the operation of the first hydraulic cylinder to cause the first hydraulic cylinder to urge the lifting frame to move between the first and second positions.

14. The apparatus according to claim 13, wherein the beam includes a hoisting device operative to lift a workpiece toward the beam, wherein when the lifting frame is in the second position and an workpiece located behind the truck is placed in operative connection with the beam through operation of the hoisting device, the hydraulic control system is operative to cause the first hydraulic cylinder to urge the lifting frame to pivot to the first position and place the workpiece on the floor of the bed between the first and second booms of the lifting frame.

15. The apparatus according to claim 13, wherein the lifting device includes a second hydraulic cylinder in operative connection with the second boom, wherein at least a portion of the second hydraulic cylinder extends over at least a portion of the second wheel well, wherein the hydraulic control system is operative to selectively control the operation of the first and the second hydraulic cylinders to cause the first and the second hydraulic cylinders to urge the lifting frame to move between the first and second positions.

16. The apparatus according to claim 15, wherein the bed of the truck includes a back end and a front end, wherein the front end of the bed is bounded by a portion of the cab, wherein the bed includes first and second side walls extending between the cab and the back end of the bed, wherein each of the first and second side walls include an inner surface in the interior of the bed, wherein the inner surfaces of the respective first and second side walls include outer surfaces of the respective first and second wheel wells, wherein the inner surfaces of the first and second side walls each include a back portion positioned between the respective first and second wheel wells and the back of the bed, wherein the minimum distance between the outer surfaces of the first and second wheel wells is smaller than the minimum distance between the back portions of the inner surfaces of the first and second side walls of the bed, wherein the bed includes a floor between the first and second side walls, wherein the first and second pivot locations are located adjacent respective portions of the floor of the bed that are adjacent the respective back portions of the inner surfaces of the side walls of the bed.

17. The apparatus according to claim 16, wherein the lifting device includes a first support frame mounted to the truck adjacent the inner surface of the first side wall of the bed, wherein the lifting device includes a second support frame mounted to the truck adjacent the inner surface of the second side wall of the bed, wherein the first and second support frames each include a first end and a second end, wherein the respective first ends of the first and second support frames extend to the respective first and second pivot locations, wherein the respective second ends of the first and second booms are in pivoting connection with the respective first ends of the first and second support frames, wherein the respective second ends of the first and second support frames extend to further locations between the cab and the wheel wells, wherein each of the first and second support frames includes at least a portion that extends over the respective first and second wheel wells, wherein the first hydraulic cylinder includes a first and a second end, wherein the second hydraulic cylinder includes a first and a second end, wherein the first end of the first hydraulic cylinder is in pivoting connection with the second end of the first support frame, wherein the second end of the first hydraulic cylinder is in pivoting connection with the first boom of the lifting frame, wherein the first end of the second hydraulic cylinder is in pivoting connection with the second end of the second support frame, wherein the second end of the second hydraulic cylinder is in pivoting connection with the second boom of the lifting frame.

18. The apparatus according to claim 17, wherein the truck includes a truck frame located under the floor of the bed, wherein the first and second support frames are each in a form of a truss comprised of a first vertical post in operative connection between an upper cord and a lower cord, wherein the first vertical posts of the first and second support frames are located at the second ends of the first and second support frames, wherein the upper cord of the first support frame extends over the first wheel well, wherein the lower cord of the first support frame extends along the floor of the bed adjacent the first wheel well, wherein the upper cord of the second support frame extends over the second wheel well, wherein the lower cord of the second support frame extends along the floor of the bed adjacent the second wheel well, wherein the lifting device includes at least one horizontal beam that extends between the first and second support frames along the floor of the bed, wherein the at least one horizontal beam is fastened to the truck frame.

19. The apparatus according to claim 18, wherein portions of the first posts of the first and second support frames extend above the first and second side walls, wherein in the first position of the lifting frame, at least one of the beam and the first ends of the first and second booms comes to rest in supporting connection with the portions of the first posts of the first and second support frames that extend above the first and second side walls.

20. The apparatus according to claim 13, wherein the lifting device includes at least one bracket located above the back of the bed, wherein portions of the bracket extend above the first side wall, wherein the bracket is operative to support a ladder in removable connection with the lifting device.
